(19) United States
(12) Patent Application Publication
(10) Pub. No.: US 2022/0230638 A1
(43) Pub. Date: Jul. 21, 2022

(54) INFORMATION PROCESSING APPARATUS, INFORMATION PROCESSING METHOD, AND PROGRAM

(71) Applicant: SONY GROUP CORPORATION, TOKYO (JP)

(72) Inventor: KAZUNORI ARAKI, TOKYO (JP)

(21) Appl. No.: 17/596,288

(22) PCT Filed: May 15, 2020
(86) PCT No.: PCT/JP2020/019395

§ 371 Date: Dec. 7, 2021

(30) Foreign Application Priority Data
Jun. 20, 2019 (JP) 2019-114590

(51) Int. Cl. G10L 15/22; G10L 15/30; G10L 15/08; G06F 21/62

(52) U.S. Cl. CPC G10L 15/22; G10L 15/30; G10L 2015/227; G06F 21/6245; G10L 2015/088; G10L 15/08

(57) ABSTRACT

An information processing apparatus according to an embodiment of the present technology includes an extraction section and a suggestion section. The extraction section extracts a deletion-target word from speech information that includes a content of speech of a target person. The suggestion section is capable of providing, to the target person, a deletion suggestion for deleting the deletion-target word when the deletion-target word is extracted. Accordingly, the deletion suggestion for deleting the deletion-target word is provided to the target person when the deletion-target word is extracted. This makes it possible to easily delete speech content to be deleted.

### TECHNICAL FIELD

The present technology relates to an information processing apparatus, an information processing method, and a program that can be applied to, for example, a voice interactive system.

### BACKGROUND ART

In the information processing apparatus disclosed in Patent Literature 1, it is determined whether information extracted from speech of a user is information regarding privacy. For example, a request that is input using speech of a user is assumed to be an inquiry addressed to another apparatus. In this case, when information regarding privacy is extracted from the speech, the user can selectively determine whether to make the inquiry addressed to the other apparatus anonymously or under the name of the user. This makes it possible to provide information to the user while protecting the privacy of the user (for example, paragraphs [0025] to [0038], and FIG. 4 in Patent Literature 1).

### CITATION LIST

### Patent Literature

Patent Literature 1: WO 2018/043113

### DISCLOSURE OF INVENTION

### Technical Problem

In such a voice interactive system or the like, contents of speech of a user are often stored in the form of a history. The stored speech contents may include a speech content that the user wants to delete. There is a need for a technology that can easily delete such a speech content to be deleted.

In view of the circumstances described above, it is an object of the present technology to provide an information processing apparatus, an information processing method, and a program that make it possible to easily delete a speech content to be deleted.

### Solution to Problem

In order to achieve the object described above, an information processing apparatus according to an embodiment of the present technology includes an extraction section and a suggestion section.

The extraction section extracts a deletion-target word from speech information that includes a content of speech of a target person.

The suggestion section is capable of providing, to the target person, a deletion suggestion for deleting the deletion-target word when the deletion-target word is extracted.

In this information processing apparatus, a deletion-target word is extracted from speech information that includes a content of speech of a target person. A deletion suggestion for deleting the deletion-target word is provided to the target person when the deletion-target word is extracted. This makes it possible to easily delete speech content to be deleted.

The deletion-target word may be a word that includes sensitive information regarding the target person.

For each extracted deletion-target word, the suggestion section may determine whether to provide the deletion suggestion.

The suggestion section may provide the deletion suggestion when determination information that is associated with the extracted deletion-target word satisfies a specified suggestion condition.

The determination information may include a sensitivity-related level of the deletion-target word. In this case, the suggestion section may provide the deletion suggestion when the sensitivity-related level exceeds a threshold.

The determination information may include the number of deletions of the deletion-target word that have been performed by another target person. In this case, the suggestion section may provide the deletion suggestion when the number of deletions exceeds a threshold.

The suggestion section may determine whether to provide the deletion suggestion by comparing information regarding the target person with information regarding another target person who has deleted the deletion-target word.

The information processing apparatus may further include a management section that manages a deletion database that stores therein the deletion-target word. In this case, the extraction section may refer to the deletion database, and may extract the deletion-target word from the speech information.

The information processing apparatus may further include a storage that stores therein a history of the speech information regarding the target person. In this case, the management section may store, in the deletion database and as the deletion-target word, a keyword that has been extracted from the speech information in the history, and has been designated to be deleted by a deletion instruction being given by the target person.

On the basis of state information regarding a state of the target person, the suggestion section may determine whether the target person is in a state in which the deletion suggestion is allowed to be provided.

When the target person is alone, the suggestion section may determine that the target person is in a state in which the deletion suggestion is allowed to be provided.

The suggestion section may present suggestion information including the deletion-target word to the target person such that deleting or not deleting the deletion-target word is selectable by the target person.

The suggestion information may include the speech information from which the deletion-target word has been extracted. In this case, the suggestion section may present the suggestion information to the target person such that deleting or not deleting the speech information from which the deletion-target word has been extracted, is selectable by the target person.

The suggestion section may present the suggestion information to the target person using at least one of an image or sound.

The information processing apparatus further includes a storage and a deletion section.

The storage stores therein a history of the speech information regarding the target person.

The deletion section deletes the speech information from the history when the target person selects deleting the deletion-target word in response to the deletion suggestion, the speech information being speech information from which the deletion-target word has been extracted.

The extraction section may extract the deletion-target word from the speech information generated by a voice interactive system that is used by the target person.

An information processing method according to an embodiment of the present technology is an information processing method that is performed by a computer system, the information processing method including extracting a deletion-target word from speech information that includes a content of speech of a target person.

A deletion suggestion for deleting the deletion-target word is provided to the target person when the deletion-target word is extracted.

A program according to an embodiment of the present technology causes a computer system to perform a process including:

extracting a deletion-target word from speech information that includes a content of speech of a target person, and providing, to the target person, a deletion suggestion for deleting the deletion-target word when the deletion-target word is extracted.

### BRIEF DESCRIPTION OF DRAWINGS

FIG. 1 schematically illustrates an example of a configuration of a voice interactive system.

FIG. 2 is a block diagram illustrating an example of a functional configuration of the voice interactive system.

FIG. 3 schematically illustrates an example of a configuration of a user log DB.

FIG. 4 schematically illustrates a configuration of a deletion DB.

FIG. 5 is a flowchart illustrating a basic example of a server apparatus providing a deletion suggestion.

FIG. 6 is a flowchart illustrating a specific example of providing a deletion suggestion.

FIG. 7 schematically illustrates an example of a deletion suggestion.

FIG. 8 schematically illustrates an example of a deletion suggestion.

FIG. 9 schematically illustrates an example of a deletion suggestion.

FIG. 10 is an example of a deletion suggestion provided by a user acting as a trigger.

FIG. 11 is an example of a deletion suggestion provided by a user acting as a trigger.

FIG. 12 schematically illustrates a deletion of speech information that is performed by a user.

FIG. 13 schematically illustrates a deletion of speech information that is performed by a user.

FIG. 14 is a flowchart illustrating an expansion of the deletion DB.

FIG. 15 is a block diagram illustrating an example of a configuration of hardware of the server apparatus.

### MODE(S) FOR CARRYING OUT THE INVENTION

Embodiments according to the present technology will now be described below with reference to the drawings.

[Voice Interactive System]

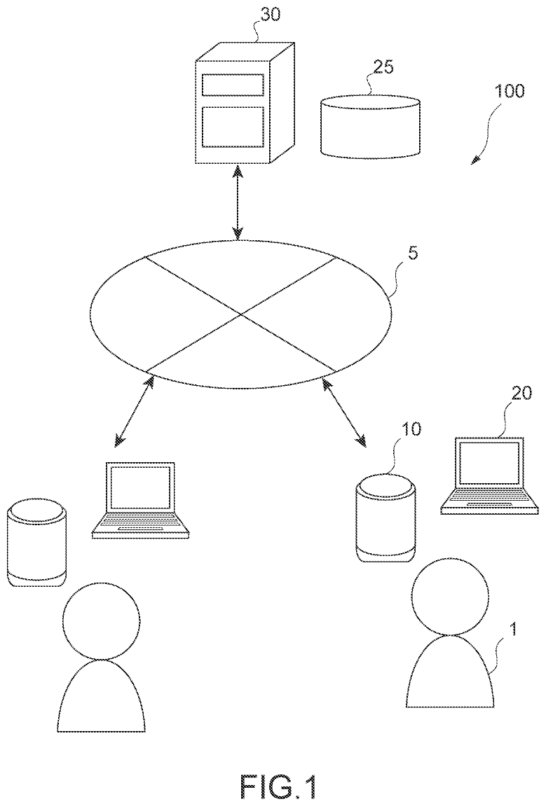

FIG. 1 schematically illustrates an example of a configuration of a voice interactive system 100 according to the present technology.

The voice interactive system 100 includes an agent 10, a user terminal 20, and a server apparatus 30. The agent 10, the user terminal 20, and the server apparatus 30 are communicatively connected to each other through a network 5.

The network 5 is constructed by, for example, the Internet or a wide area communication network. Moreover, for example, any wide area network (WAN) or any local area network (LAN) may be used, and a protocol used to construct the network 5 is not limited.

In the present embodiment, a so-called cloud service is provided using the network 5 and the server apparatus 30. Thus, it can also be said that the user terminal 20 is connected to a cloud network.

Note that a method for communicatively connecting the user terminal 20 and the server apparatus 30 is not limited. For example, the user terminal 20 and the server apparatus 30 may be connected to each other using near field communication such as Bluetooth (registered trademark) without a cloud network being constructed.

The agent 10 is typically constructed by artificial intelligence (AI) that performs, for example, deep learning. The agent 10 can interact with the user 1.

For example, the user 1 can input various requests and instructions using, for example, sound and a gesture. The agent 10 can perform various processes in response to, for example, various requests and instructions that are input by the user 1.

For example, the agent 10 includes a learning section and an identification section (of which illustrations are omitted). The learning section performs machine learning on the basis of input information (training data), and outputs a learning result. Further, the identification section performs identification (such as determination and prediction) with respect to the input information on the basis of the input information and the learning result.

For example, a neural network and deep learning are used as a learning method performed by the learning section. The neural network is a model obtained by mimicking a human brain neural network, and includes three types of layers that are an input layer, an intermediate layer (a hidden layer), and an output layer.

The deep learning is a model using a neural network having a multilayered structure, where a complex pattern hidden in large volumes of data can be learned by characteristic learning being repeated in each layer.

The deep learning is used to, for example, identify an object in an image and a word in a vocalization. Of course, the deep learning can also be applied to the voice interactive system according to the present embodiment.

Further, a neurochip or a neuromorphic chip into which a concept of a neural network has been incorporated can be used as a hardware structure used to perform such machine learning.

Further, examples of the problem setting for machine learning include those for supervised learning, unsupervised learning, semi-supervised learning, reinforcement learning, inverse reinforcement learning, active learning, and transfer learning.

For example, in supervised learning, a feature value is learned on the basis of given labeled training data. This makes it possible to derive a label of unknown data.

Further, in unsupervised learning, large volumes of unlabeled training data are analyzed to extract a feature value, and clustering is performed on the basis of the extracted feature value. This makes it possible to analyze a trend and predict the future on the basis of large volumes of unknown data.

Furthermore, semi-supervised learning is an approach obtained by mixing supervised learning and unsupervised learning, where a feature value is learned using supervised learning, and then large volumes of training data are given using unsupervised learning. In this approach, learning is repeatedly performed while a feature value is automatically calculated.

Moreover, reinforcement learning deals with a problem in which an agent in an environment observes a current state to determine an action to be taken. The agent selects an action to obtain a reward from the environment, and learns a policy that maximizes rewards though a series of actions. The above-described learning of an optimal solution in an environment makes it possible to replicate the human judgement and to cause a computer to learn judgment better than the human judgement.

The agent 10 can also generate virtual sensing data using machine learning. For example, the agent 10 can predict a certain piece of sensing data from another piece of sensing data to use the predicted piece of sensing data as input information, such as generating positional information from input image information.

Further, the agent 10 can also generate a piece of sensing data from a plurality of other pieces of sensing data. Furthermore, the agent 10 can also predict necessary information and generate specified information from sensing data.

Examples of the user terminal 20 include various apparatuses that can be used by the user 1. For example, a personal computer (PC) or a smartphone is used as the user terminal 20. The user 1 can access the voice interactive system 100 through the user terminal 20. For example, the user 1 can perform various settings and view various history information using the user terminal 20.

The server apparatus 30 can provide application services regarding the voice interactive system 100. In the present embodiment, the server apparatus 30 can manage a history of speech information that includes a content of speech of the user 1. Further, the server apparatus 30 can delete specified speech information from the history of the speech information in response to, for example, an instruction given by the user 1.

Further, the server apparatus 30 can extract a deletion-target word from the speech information and provide, to the user 1, a deletion suggestion for deleting the deletion-target word.

As illustrated in FIG. 1, the server apparatus 30 includes a database 25, and various information regarding the voice interactive system 100 can be stored in the database 25.

In the example illustrated in FIG. 1, there are two users 1. However, the number of users 1 allowed to use the voice interactive system 100 is not limited. Further, a plurality of users 1 may share the agent 10 and the user terminal 20 in common.

For example, a married couple and family members may share, for example, the agent 10 in common. In this case, for example, a husband, a wife, and a child are typically individual users 1 who use this voice interactive system 100.

In the present embodiment, the extraction of a deletion-target word from speech information and the provision of a deletion suggestion are performed for each user 1. For example, when a deletion-target word is extracted from speech information regarding a user A, a deletion suggestion is provided to the same user A.

In other words, from among a plurality of users 1 allowed to use the voice interactive system 100, a target person who is a target for the extraction of a deletion-target word and a target person who is a target for the provision of a deletion suggestion are the same user 1.

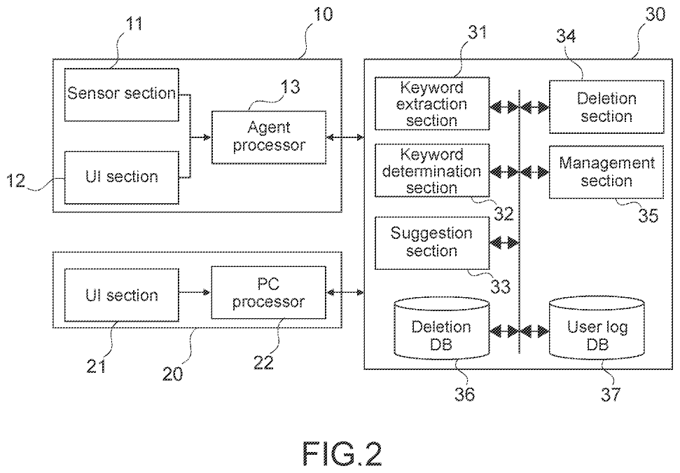

FIG. 2 is a block diagram illustrating an example of a functional configuration of the voice interactive system 100.

As illustrated in FIG. 2, the agent 10 includes a sensor section 11, a user interface (UI) section 12, and an agent processor 13.

The sensor section 11 can primarily detect various information regarding surroundings of the agent 10. For example, a microphone that can detect sound generated in the surroundings and a camera that can capture an image of the surroundings are provided as the sensor section 11.

For example, sound (speech sound) produced by the user 1 can be detected using the microphone. Further, an image of the face and the like of the user 1 and an image of surroundings of the user 1 can be captured using the camera. Furthermore, an image of a space in which the agent 10 is arranged can be captured.

Moreover, any sensor such as a ranging sensor may be provided as the sensor section 11. For example, the sensor section 11 includes an acceleration sensor, an angular velocity sensor, a geomagnetic sensor, an illuminance sensor, a temperature sensor, or an atmospheric-pressure sensor, and detects, for example, acceleration, an angular velocity, a direction, illuminance, a temperature, or a pressure regarding the agent 10.

For example, when the agent 10 including the sensor section 11 is carried or worn by the user 1, the various sensors described above can detect various information as information regarding the user 1, that is, for example, information that indicates, for example, a motion and an orientation of the user 1.

Further, the sensor section 11 may include sensors that detect biological information regarding the user 1, such as pulse, sweating, brain waves, a sense of touch, a sense of smell, and a sense of taste. The agent processor 13 may include a processing circuit that acquires information that indicates feelings of the user by analyzing information detected by these sensors and/or data of an image detected by a camera or of sound detected by a microphone. Alternatively, the information and/or the data described above may be output to the UI section 12 without being analyzed, and analysis may be performed by, for example, the server apparatus 30.

Further, the sensor section 11 may include a position detecting mechanism that detects an indoor or outdoor position. Specifically, examples of the position detecting mechanism may include a global navigation satellite system (GNSS) receiver such as a Global Positioning System (GPS) receiver, a Global Navigation Satellite System (GLONASS) receiver, and a BeiDou Navigation Satellite System (BDS) receiver, and/or a communication apparatus. The communication apparatus detects a position using technologies such as Wi-Fi (registered trademark), multi-input multi-output (MIMO), and a cellular communication (such as position detection using a mobile base station, femtocell); or technologies such as near field communication (such as Bluetooth Low Energy (BLE), Bluetooth (registered trademark)) and low-power wide-area (LPWA).

The UI section 12 of the agent 10 includes any UI device such as image display devices such as a projector and a display; sound output devices such as a speaker; and operation devices such as a keyboard, a switch, a pointing device, and a remote controller. Of course, a device such as a touch panel that includes both a function of an image display device and a function of an operation device is also included.

Further, various graphical user interfaces (GUIs) displayed on, for example, a display or a touch panel can be considered elements included in the UI section 12.

The agent processor 13 can perform various processes that includes interacting with the user 1. For example, the agent processor 13 analyzes a content of speech of the user 1 on the basis of speech sound detected by the sensor section 11.

Further, the user 1 having spoken can be identified on the basis of a detection result detected by the sensor section 11. For example, the user 1 can be identified on the basis of, for example, an image or sound (a voice) detected by the sensor section 11.

Furthermore, it is possible to determine whether user 1 is alone in a space in which there are the agent 10 and the user 1. In this case, a result of detection performed by, for example, a proximity sensor may be used in combination. Information (a detection result) used for determination, and an algorithm used for determination are not limited, and may be set discretionarily.

Moreover, any condition information regarding a condition of the user 1 or any state information regarding a state of the user 1 may be detected on the basis of a detection result detected by the sensor section 11. Note that the condition information includes any information indicating in what condition the user 1 is. The state information includes any information indicating in what state the user 1 is.

Note that the condition information regarding a condition of the user 1 and the state information regarding a state of the user 1 may be detected on the basis of a result of detection performed not only by the sensor section 11 included in the agent 10, but also by, for example, a sensor of another apparatus that can operate in conjunction with the agent 10. For example, a result of detection performed by a sensor that is included in, for example, a smartphone carried by the user 1, or a result of detection performed by a sensor of an apparatus that can cooperate with the agent 10 through, for example, a smartphone may be used.

Further, the agent processor 13 can acquire time information such as a time stamp. For example, when, for example, the user 1 speaks, a result of analyzing a content of the speech, and a time stamp that indicates a speech time can be stored in the form of a history in association with each other. Note that the method for acquiring a time stamp is not limited, and any method may be adopted. For example, the time from, for example, a cellular network (long term evolution: LTE) may be used.

In the present embodiment, a speech content analyzed by the agent processor 13, a time stamp that indicates a speech time, and a user ID that is identification information used to identify the user 1 having spoken are used as speech information that includes a content of speech of a target person. Without being limited thereto, any information including speech content can be used as speech information according to the present technology. Of course, only a speech content may be used as speech information.

The user terminal 20 includes a UI section 21 and a PC processor 22.

The UI section 21 of the user terminal 20 includes any UI device such as image display devices such as a projector and a display; sound output devices such as a speaker; and operation devices such as a keyboard, a switch, a pointing device, and a remote controller. Of course, a device such as a touch panel that includes both a function of an image display device and a function of an operation device is also included.

Further, various GUIs displayed on, for example, a display or a touch panel can be considered elements included in the UI section 21.

The PC processor 22 can perform various processes on the basis of, for example, an instruction input by the user 1 or a control signal from the server apparatus 30. Various processes are performed that include, for example, displaying a history of speech information and displaying a GUI used to delete speech information in a history.

The server apparatus 30 includes a keyword extraction section 31, a keyword determination section 32, a suggestion section 33, a deletion section 34, and a management section 35. Further, the server apparatus 30 includes a user log DB 37 and a deletion DB 36.

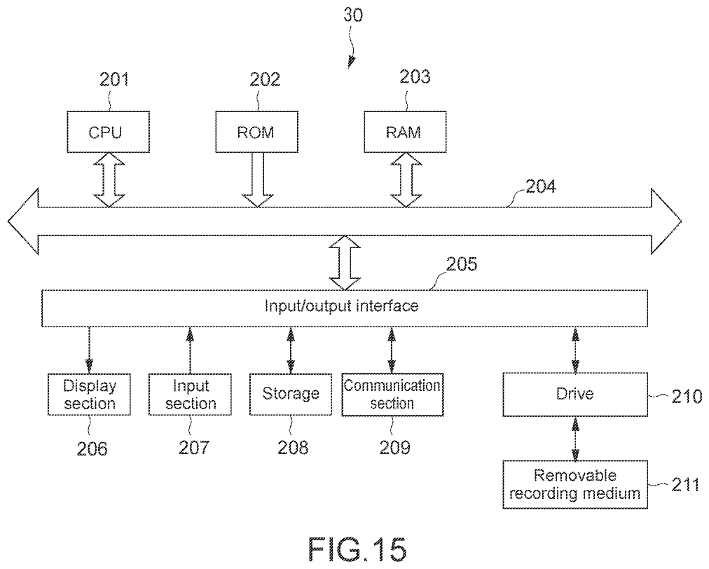

The server apparatus 30 includes hardware, such as a CPU, a ROM, a RAM, and an HDD, that is necessary for a configuration of a computer (refer to FIG. 15). When the CPU loads, into the RAM, a program according to the present technology that is recorded in, for example, the ROM in advance and executes the program, this results in the respective functional blocks illustrated in FIG. 2 being implemented, and in an information processing method according to the present technology being performed.

For example, the server apparatus 30 can be implemented by any computer such as a PC. Of course, hardware such as an FPGA or an ASIC may be used. Further, dedicated hardware such as an integrated circuit (IC) may be used in order to implement the respective blocks illustrated in FIG. 2.

The program is installed on the server apparatus 30 through, for example, various recording media. Alternatively, the installation of the program may be performed via, for example, the Internet.

Note that the type and the like of a recording medium that records therein a program are not limited, and any computer-readable recording medium may be used. For example, any recording medium that non-transiently records therein data may be used.

The keyword extraction section 31 extracts a keyword from speech information acquired by the agent 10. In other words, a keyword is extracted from a speech content analyzed by the agent 10.

The method for extracting a keyword from a speech content is not limited. Any method such as extracting a noun phrase by morphological analysis may be adopted. Further, any learning algorithm for, for example, various machine learning using the neural network or the deep learning described above may be performed.

The number of keywords extracted is not limited, and a plurality of keywords may be extracted from a single speech content.

The keyword determination section 32 determines whether a keyword extracted by the keyword extraction section 31 matches a deletion-target word stored in the deletion DB. When the extracted keyword matches the deletion-target word, that is, when the extracted keyword is stored in the deletion DB as the deletion-target word, the extracted keyword has been determined to be the deletion-target word.

In the present embodiment, an extraction section that extracts a deletion-target word from speech information that includes a content of speech of a target person is implemented by the keyword extraction section 31 and the keyword determination section 32. In other words, in the present embodiment, a deletion-target word is extracted from a speech content by extracting a keyword from the speech content and determining whether the extracted keyword is the deletion-target word.

The case in which a keyword extracted from speech information matches a deletion-target word may be hereinafter referred to as the case in which a deletion-target word has been extracted from speech information. Further, a keyword that matches a deletion-target word may be referred to as a deletion-target word extracted from speech information.

The suggestion section 33 can provide, to the user 1, a deletion suggestion for deleting a deletion-target word when the deletion-target word is extracted.

In the present embodiment, for each extracted deletion-target word, the suggestion section 33 determines whether to provide a deletion suggestion. For example, a deletion suggestion is provided when determination information associated with an extracted deletion-target word satisfies a specified suggestion condition.

The deletion suggestion is provided by presenting suggestion information including a deletion-target word to the user 1 such that the user 1 can select deleting or not deleting the deletion-target word. More specifically, suggestion information that is “There is a speech content including XXXX (a deletion-target word). Do you want to delete it?” is presented to the user 1 using at least one of an image or sound.

In the present embodiment, suggestion information is automatically presented to the user 1 through the agent 10 or the user terminal 20 regardless of whether, for example, inquiries have been made by the user 1.

Various settings regarding a presentation of suggestion information, such as a setting of a timing of presenting the suggestion information and a setting of a specific content of the suggestion information, may be performable by the user 1. For example, a timing of providing a deletion suggestion (a timing of presenting suggestion information) such as “10:00 p.m. on Sunday” may be settable.

Note that suggestion information may include speech information from which a deletion-target word has been extracted. Then, the suggestion information may be presented to the user 1 such that the user 1 can select deleting or not deleting the speech information from which the deletion-target word has been extracted.

For example, suggestion information that is “There is a speech content including XXXX (a deletion-target word), that is, a speech content of <Please check XXXX (the deletion-target word)>. Do you want to delete the speech content?”, may be presented.

The deletion section 34 can delete speech information from a history of speech information. In the present embodiment, speech information from which a deletion-target word has been extracted is deleted from the history when the user 1 selects deleting the deletion-target word in response to a deletion suggestion provided by the suggestion section 33.

The user 1 himself/herself performs, for example, viewing of a history of speech information and a search for speech information, and inputs an instruction to delete specified speech information. In such a case, the deletion section 34 also deletes speech information in response to the instruction. In other words, speech information can also be deleted by, for example, an operation performed by the user himself/herself if there is no deletion suggestion.

Further, in response to, for example, speech information being deleted, the deletion section 34 can update information stored in the deletion DB.

The management section 35 manages the deletion DB 36 and the user log DB 37. In the present embodiment, the management section 35 performs, for example, addition of a deletion-target word stored in the deletion DB 36, and an update of determination information. For example, the management section 35 can store, in the deletion DB 36 and as a deletion-target word, a keyword that has been extracted from speech information in a history, and has been designated to be deleted by a deletion instruction being given by the user 1.

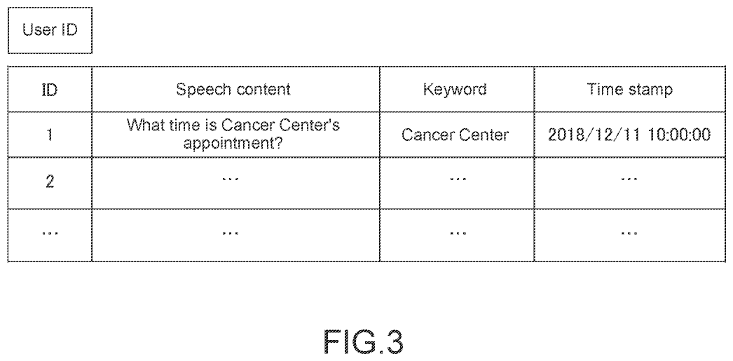

FIG. 3 schematically illustrates an example of a configuration of the user log DB 37.

In the present embodiment, the user log DB 37 is constructed for each user 1. In other words, the user log DB 37 is constructed in association with a user ID used to identify the user 1.

A record that includes a speech content, a keyword, and a time stamp is stored in the user log DB 37 for each ID. In other words, speech information (a speech content+a time stamp) acquired from the agent 10 and a keyword extracted by the keyword extraction section 31 are stored in association with each other.

In the present embodiment, the user log DB 37 corresponds to a history of speech information. Further, deleting a record of a specified ID from the user log DB 37 corresponds to deleting specified speech information from the history of speech information.

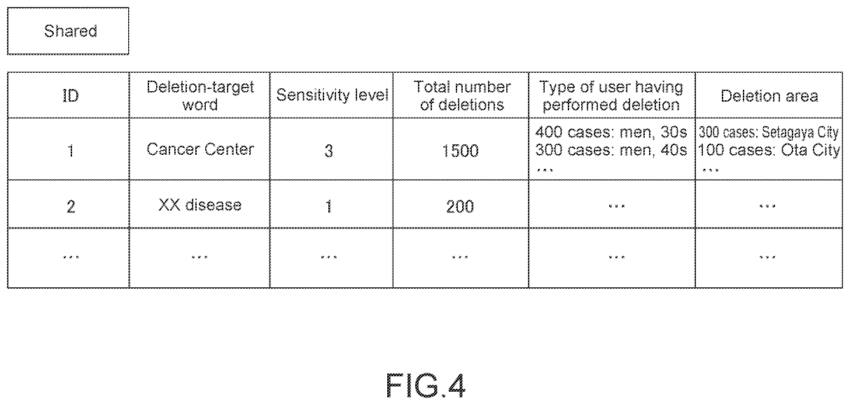

FIG. 4 schematically illustrates a configuration of the deletion DB 36.

The deletion DB 36 is a DB used in the entirety of the voice interactive system 100 in common. Note that the present technology can also be applied when the deletion DB 36 is constructed for each user 1.

A record that includes a deletion-target word, a sensitivity level, a total number of deletions, the type of user having performed deletion, and a deletion area are stored in the deletion DB 36 for each ID.

In the present embodiment, a word that includes sensitive information regarding the user 1 is set to be a deletion-target word. Examples of the sensitive information include information regarding political views, information regarding religion, information regarding race, information regarding ethnicity, information regarding healthcare, and information regarding victimization by crime that the user 1 does not want other people to know.

Note that there is no need to clearly define whether specified information is included in sensitive information. For example, a word that the user 1 considers to be sensitive information or wants to delete (a word that the user 1 does not want to leave in a history) may be set to be a deletion-target word including sensitive information.

Further, an attribute and the like of a word set to be a deletion-target word is not limited, and the present technology can be applied, with any word being set to be a deletion-target word. For example, personal information with which an individual can be specified may be set to be a deletion-target word.

The sensitivity level is a sensitivity-related level of a deletion-target word. For example, a higher sensitivity level is set for a word that includes information that the user 1 more strongly does not want other people to know or information that has a greater impact on the sensitivity of the user 1. The method for setting a sensitivity level is not limited, and, for example, the sensitivity level may be set by the user 1. For example, an average of sensitivity levels or the like set by respective users for a specified deletion-target word may be stored as a sensitivity level of the deletion-target word.

The total number of deletions is a sum of the number of times the user 1 (including a certain user and a user other than the certain user) using the voice interactive system 100 has deleted a deletion-target word. In other words, the total number of deletions includes the number of deletions of a deletion-target word that have been performed by another target person.

The total number of deletions may be used as a parameter used to determine a sensitivity level. For example, a higher sensitivity level may be set for a larger total number of deletions.

The type of user having performed deletion is classification information regarding the user 1 (including a certain user and a user other than the certain user) having deleted a deletion-target word. In the example illustrated in FIG. 4, the user 1 is classified according to gender and age. Then, the number of cases in which a deletion-target word has been deleted is stored for each classification item.

The deletion area is an area in which the user 1 (including a certain user and a user other than the certain user) having deleted a deletion-target word lives. For example, the deletion area is acquired from user information that is input when, for example, the user 1 uses the voice interactive system. In the example illustrated in FIG. 4, the number of cases in which a deletion-target word has been deleted is stored for each area.

Moreover, various information may be stored.

In the present embodiment, the sensitivity level and the total number of deletions that are stored in the deletion DB 36 are used as determination information that is associated with a deletion-target word. For example, when the sensitivity level exceeds a threshold, it is determined that determination information satisfies a specified suggestion condition, and thus a deletion suggestion is provided.

Further, when the total number of deletions exceeds a threshold, it is determined that determination information satisfies a specified suggestion condition, and thus a deletion suggestion is provided. Note that, for example, the number of times a deletion-target word has been deleted by another user 1 included in the specified condition may be used instead of the total number of deletions. Further, only the number of times the other user 1 has performed deletion may be used as determination information.

Note that it may be determined that determination information satisfies a specified suggestion condition when one of two conditions that are a condition that the sensitivity level exceeds a threshold and a condition that the total number of deletions exceeds a threshold is satisfied (OR condition). Alternatively, it may be determined that determination information satisfies a specified suggestion condition when both of the two conditions that are the condition that the sensitivity level exceeds a threshold and the condition that the total number of deletions exceeds a threshold are satisfied (AND condition).

Further, the term “exceeding a threshold” includes both “being equal to or greater than the threshold”, or “being greater than the threshold”. Whether a suggestion condition is determined to be satisfied when the sensitivity level or the like is equal to or greater than a threshold, or when the sensitivity level or the like is greater than a threshold, may be set as appropriate.

Further, the type of user having performed deletion and the deletion area correspond to information regarding another target person who has deleted a deletion-target word. In the present embodiment, the type of user having performed deletion and the deletion area, which also include own information, are stored. For example, when a user has deleted a deletion-target word in the past, information regarding the user is stored as the type of user and the deletion area.

Without being limited thereto, only information regarding another user 1 may be stored as the type of user and the deletion area. Such a setting is also effective when, for example, the deletion DB is constructed for each user 1.

It may be determined whether to provide a deletion suggestion by comparing information regarding the user 1 (a target person) with information regarding another user 1 (another target person).

For example, a deletion suggestion is provided when the type of user having performed deletion or the deletion area for the other target person matches or is close to the type of user having performed deletion or the deletion area for the user 1 (the target person). Further, for example, when comparison is performed with respect to, for example, whether the other user 1 has deleted similar information (a similar deletion-target word) and when deletion-target words are similar as a whole, a deletion suggestion may be provided.

Information regarding the user 1 (a target person) and information regarding another target person who has deleted a deletion-target word can also be considered determination information associated with a deletion-target word.

Further, any condition may be set to be a suggestion condition for providing a deletion suggestion.

Note that the deletion DB 36 and the user log DB 37 are constructed in the database 25 illustrated in FIG. 1. In the present embodiment, a storage that stores therein a history of speech information regarding a target person is implemented by the database 25.

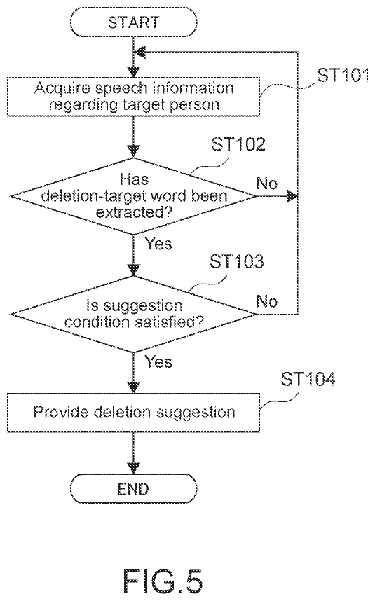

FIG. 5 is a flowchart illustrating a basic example of the server apparatus 30 providing a deletion suggestion.

Speech information (a user ID, a speech content, and a type stamp) that is generated by the agent 10 is acquired (Step 101).

For example, the speech information for each user 1 is generated by the agent 10 when, for example, a plurality of users 1 is having a talk. The server apparatus 30 acquires the speech information for each user 1.

It is determined whether a deletion-target word has been extracted from the speech information (Step 102).

When it has been determined that the deletion-target word has been extracted from the speech information (Yes in Step 102), it is determined whether a suggestion condition for providing a deletion suggestion is satisfied (Step 103).

When it has been determined that the suggestion condition is satisfied, the deletion suggestion is provided (Step 104).

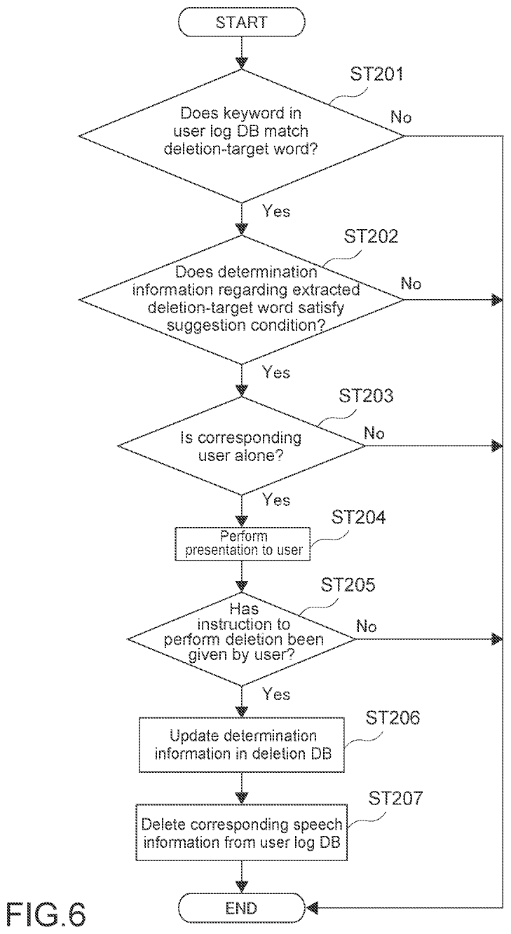

FIG. 6 is a flowchart illustrating a specific example of providing a deletion suggestion.

The keyword determination section 32 determines whether a keyword stored in the user log DB 37 matches a deletion-target word in the deletion DB 36 (Step 201). When it has been determined that the keyword matches the deletion-target word (Yes in Step 201), it has been determined that the deletion-target word has been extracted from a speech content from which the keyword has been extracted, and the process moves on to Step 202.

In Step 202, a “sensitivity level,” a “total number of deletions”, a “type of user having performed deletion”, and a “deletion area” that are determination information included in the deletion DB 36 and related to a corresponding deletion-target word are referred to. Then, it is determined whether the determination information satisfies a suggestion condition.

When it has been determined that the determination information satisfies the suggestion condition, it is determined whether the user 1 is in a state in which a deletion suggestion is allowed to be provided, on the basis of state information regarding a state of the user 1 (a target person) corresponding to a user ID that is included in speech information from which the deletion-target word has been extracted. In the present embodiment, it is determined that the user 1 is in a state in which a deletion suggestion is allowed to be provided when the user 1 is alone.

This makes it possible to prevent sensitive information regarding the user 1 corresponding to a target person from being known to another user 1.

When it has been determined that the user 1 is alone (Yes in Step 203), the deletion suggestion is provided to the user 1 by the suggestion section 33 (Step 204).

For example, it is assumed that the user 1 tells that the user 1 suffered from asthma in the past. When “asthma” is stored in the deletion DB 36 as a deletion-target word, “asthma” is extracted from a speech content as a deletion-target word.

When a sensitivity level that is associated with “asthma” satisfies a suggestion condition, a deletion suggestion is provided to the user 1 by the suggestion section 33.

For example, inquiries about whether speech information that includes a speech content from which “asthma” has been extracted is to be deleted from the user log DB 37, are made addressed to the user 1. The user 1 can select deleting or not deleting with respect to a deletion suggestion.

Note that it may be determined, in Step 203, whether, in the surroundings, there is only a person to whom a deletion suggestion is allowed to be provided, instead of the determination of whether the user 1 is alone. For example, in addition to the user 1, a specific person, such as a family member of a married couple or of a parent and his/her child, who is allowed to know sensitive information with no problem may be individually settable. A plurality of the specific persons can also be set, and a deletion suggestion may be provided to a plurality of persons.

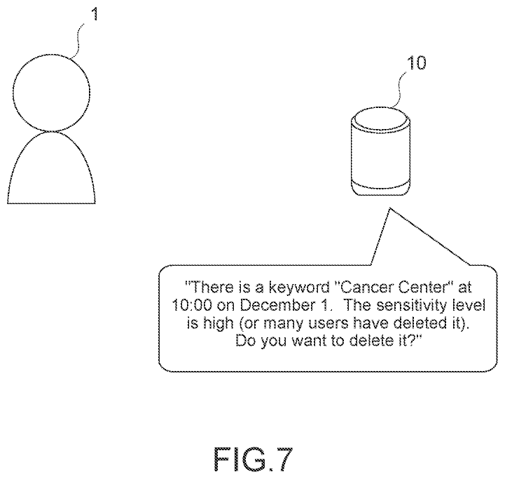

FIGS. 7 to 9 schematically illustrate examples of a deletion suggestion.

In the example illustrated in FIG. 7, suggestion information that is “There is a keyword “Cancer Center” at 10:00 on December 1. The sensitivity level is high. Do you want to delete it?” is presented to the user 1 using sound. At this point, the reason that the suggestion information has been presented may be presented.

For example, the suggestion information presented to the user 1 may include a reason such as “the sensitivity level is high” or “many users have deleted it”. For example, suggestion information that is “There is a keyword “Cancer Center” at 10:00 on December 1. Many users have deleted it. Do you want to delete it?” may be presented to the user 1 using sound.

For example, the user 1 can input an instruction to delete a deletion-target word using sound. In other words, it is possible to select deleting or not deleting a deletion-target word in response to a deletion suggestion.

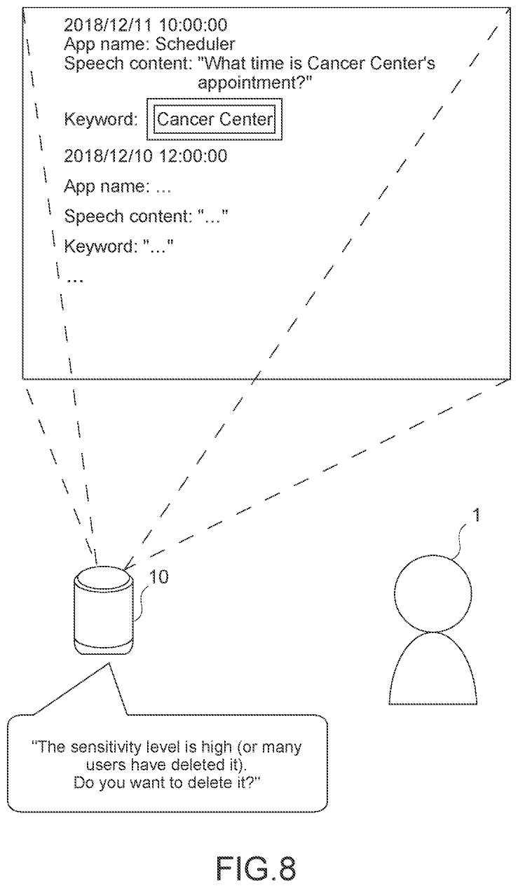

In the example illustrated in FIG. 8, suggestion information is presented using sound and an image.

Specifically, suggestion information that includes a time stamp, an application (app) name such as Scheduler, a deletion-target word (“Cancer Center”), and a speech content from which the deletion-target word has been extracted (“What time is Cancer Center's appointment?”) is displayed in the form of an image using, for example, a projector.

Further, suggestion information that is “The sensitivity level is high (many users have deleted it). Do you want to delete it?” is presented to the user 1 by the agent 10 using sound.

For example, the user 1 can input an instruction to delete a deletion-target word using sound while confirming suggestion information displayed in the form of an image. In other words, it is possible to select deleting or not deleting a deletion-target word in response to a deletion suggestion. Note that suggestion information may be presented only in the form of an image without being presented using sound. In this case, for example, an image that includes “The sensitivity level is high (many users have deleted it). Do you want to delete it?” is displayed. Conversely, suggestion information may be presented only using sound.

Note that, in the example illustrated in FIG. 8, a time stamp, an app name, a keyword, and a speech content from which the keyword has been extracted are also displayed as speech-information-related information that does not include a deletion-target word. Of course, a target (information) to be displayed is not limited to being displayed using the classification items illustrated in FIG. 8, and the classification item used for display may be set discretionarily.

Further, a deletion-target word is highlighted to be displayed such that the user 1 can identify a deletion-target word. As described above, the highlighting and displaying a deletion-target word such that the deletion-target word can be identified is also included in the presenting suggestion information. Note that a specific highlighting-and-displaying method is not limited, and any method such as a method for controlling a color of a text or the size of a text, a method for adding another image of, for example, an arrow or a frame, and display with highlight may be adopted.

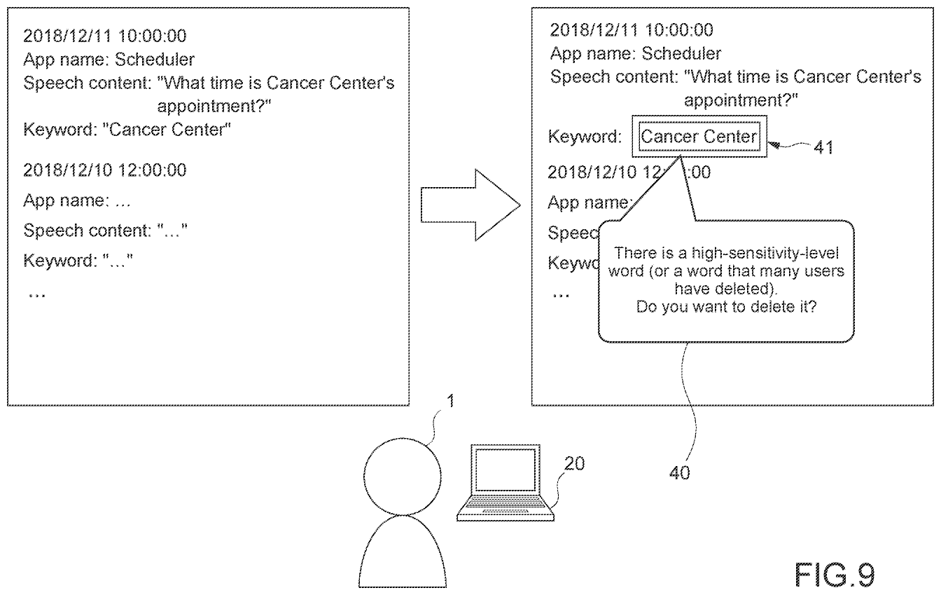

In the example illustrated in FIG. 9, it is assumed that, using the user terminal 20, the user 1 accesses a dedicated page on which a history of speech information is available. In other words, a deletion suggestion is provided in response to an instruction to view (an operation of viewing) the history of speech information.

For example, first, a history of speech information is displayed, as illustrated on the left in FIG. 9. Then, when it has been determined that the user 1 is in a state in which a deletion suggestion is allowed to be provided, that is, for example, when it has been determined that the user 1 is alone, suggestion information is presented to the user 1.

Specifically, as illustrated on the right in FIG. 9, a deletion-target word is highlighted to be displayed. Further, a balloon 40 that includes “There is a high-sensitivity-level word. Do you want to delete it?” is displayed such that the balloon 40 is adjusted to the position of the deletion-target word 41 that has been highlighted to be displayed. The displaying the balloon 40 is included in the presenting suggestion information.

For example, the user 1 can input an instruction to delete a deletion-target word by operating the user terminal 20 while confirming a history and the balloon 40 of speech information displayed as suggestion information. In other words, it is possible to select deleting or not deleting a deletion-target word in response to a deletion suggestion. Note that an operation method for inputting a deletion instruction is not limited. Further, any GUI or the like such as a button used to input a deletion instruction may be displayed.

Further, when a smartphone or the like is used as the user terminal 20, notification information regarding, for example, a batch may be displayed on an icon related to an application related the voice interactive system 100.

For example, notification information is displayed in response to a deletion-target word being extracted. Alternatively, notification information is displayed when it has been determined that the user 1 is in a state in which a deletion suggestion is allowed to be provided. Due to the notification information being displayed, the user 1 can grasp the extraction of a deletion-target word. This enables the user to view a history of speech information at an appropriate timing for the user.

The displaying notification information is also included in the presenting suggestion information.

For example, it is assumed that one of the pieces of suggestion information illustrated in FIGS. 7 to 9 is presented to the user 1, and the user 1 gives an instruction to delete a deletion-target word in response to a deletion suggestion (Yes in Step 205).

The deletion section 34 updates determination information that is stored in the deletion DB 36 and associated with the deletion-target word, on the basis of the instruction to delete the deletion-target word that has been given by the user 1 (Step 206). For example, the deletion section 34 increments a numerical value of the total number of deletions of the determination information.

Further, the deletion section 34 deletes, from a history, speech information from which the deletion-target word has been extracted (Step 207). For example, with reference to FIG. 3, it is assumed that the user 1 gives an instruction to delete the deletion-target word “Cancer Center”. In this case, the deletion section 34 deletes the speech content “What time is Cancer Center's appointment?”, the keyword “Cancer Center”, and the time stamp “2018/12/11 10:00:00”, which are stored in the user log DB 37 and included in a record of the ID “1”.

As described above, in the server apparatus 30 according to the present embodiment, a deletion-target word is extracted from speech information regarding a content of speech of the user 1. When a deletion-target word has been extracted, a deletion suggestion for deleting the deletion-target word is provided to the user 1. This makes it possible to easily delete a speech content to be deleted.

In the voice interactive system, a speech content exchanged between a user and, for example, an agent is generally stored by a service-provider side, in order to improve services and perform analysis. However, the speech content may include sensitive information such as a regular health problem, a religion, and a belief.

Thus, according to the present technology, when a deletion-target word that includes sensitive information has been extracted from speech information regarding the user 1, a deletion suggestion for deleting the deletion-target word is provided. In other words, a deletion suggestion is voluntarily provided by a system side. This enables the user 1 to efficiently find a word that includes sensitive information and to delete the word as necessary.

For example, it is very difficult for a user to remember all of the contents of speech of the user when the user has a talk with, for example, an agent every day. In other words, it is difficult for a user to keep track of whether the user has uttered a word that includes sensitive information or the like that the user does not want to leave in a history. For example, the user may unconsciously utter the word including sensitive information or the like without being aware of it.

Further, the voice interactive system 100 may be started and a content of speech of a user may be acquired by the agent 10 without the user being aware of it. In such a case, it is often the case that the user is even not aware that the content of the speech of the user is stored in a history.

It is very difficult for the user 1 to retrieve and delete, from a history of a speech content, potentially stored sensitive information or the like that is not expected by the user 1.

According to the present technology, a deletion suggestion is provided in response to a deletion-target word being extracted, regardless of whether the user 1 is expected. This enables the user 1 to appropriately delete a speech content including a word to be deleted as necessary. In other words, it is possible to easily delete a speech content to be deleted.

<Deletion Suggestion Provided by User 1 Acting as Trigger>

In the voice interactive system 100 according to the present embodiment, a deletion suggestion can also be provided by the user 1 acting as a trigger. In other words, a deletion suggestion may be provided in response to a request or an instruction from the user 1, without being limited to being voluntarily provided by a system side.

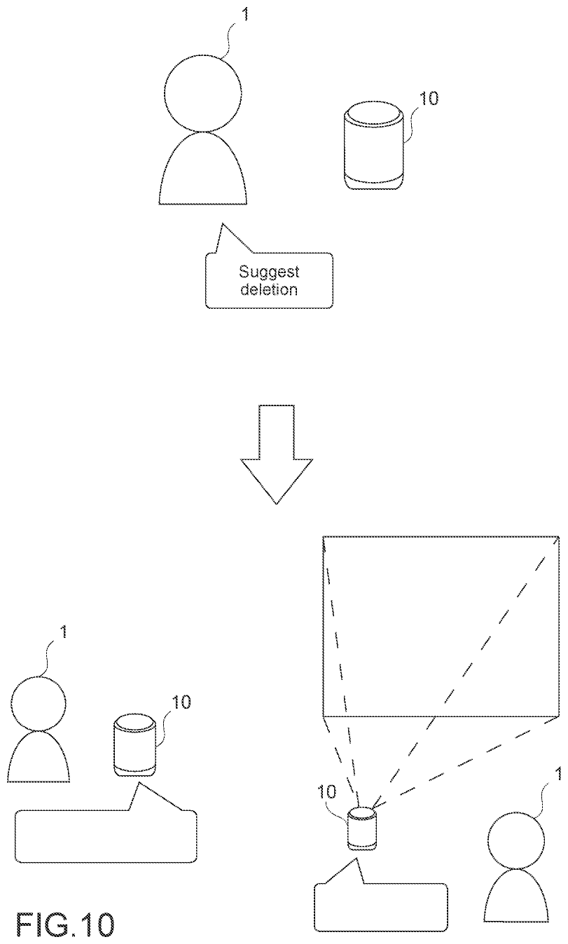

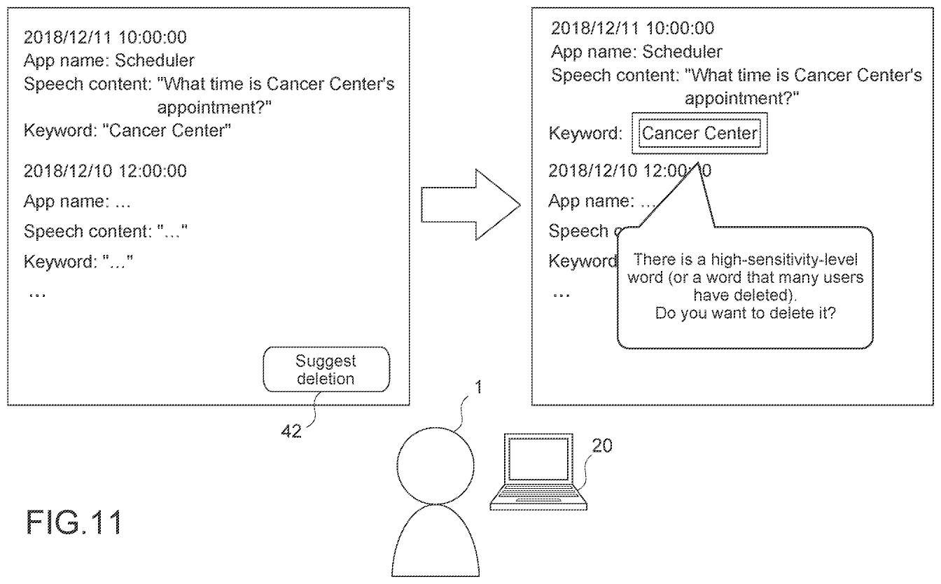

FIGS. 10 and 11 illustrate examples of a deletion suggestion provided by the user 1 acting as a trigger.

As illustrated in FIG. 10, the user 1 speaks to the agent 10 “Suggest deletion”. A speech content is analyzed and transmitted to the server apparatus 30 by the agent 10.

The server apparatus 30 detects input of an instruction to provide a deletion suggestion, on the basis of the speech content transmitted by the agent 10. Consequently, the deletion suggestion is provided by the suggestion section 33, as illustrated in FIG. 10. For example, suggestion information is presented to the user 1 using an image or sound, as illustrated in, for example, FIGS. 7 and 8.

It is assumed that, using the user terminal 20, the user 1 accesses a dedicated page on which a history of speech information is available, as illustrated in FIG. 11. In the present embodiment, a deletion suggestion button 42 is provided to a dedicated page on which a history of speech information is displayed.

The user 1 can give an instruction to provide a deletion suggestion by selecting the deletion suggestion button 42.

For example, a deletion suggestion as illustrated in FIG. 9 is provided by the suggestion section 33 when the deletion suggestion button 42 is selected. In other words, a deletion suggestion is provided, with the selection of the deletion suggestion button 42 being used as a trigger.

Since a deletion suggestion is provided using, for example, an operation of the user 1 as a trigger 1, it is possible to delete sensitive information or the like at a timing desired by the user 1.

<Deletion of Speech Content that is Performed by User (without Deletion Suggestion)>

As described above, deletion can also be performed by, for example, an operation of the user 1 when there is no deletion suggestion.

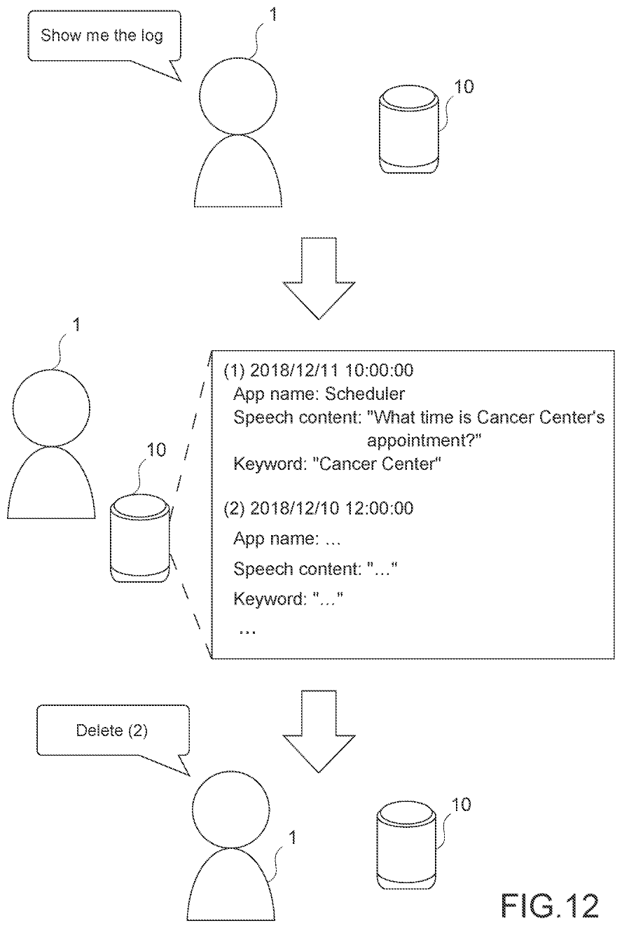

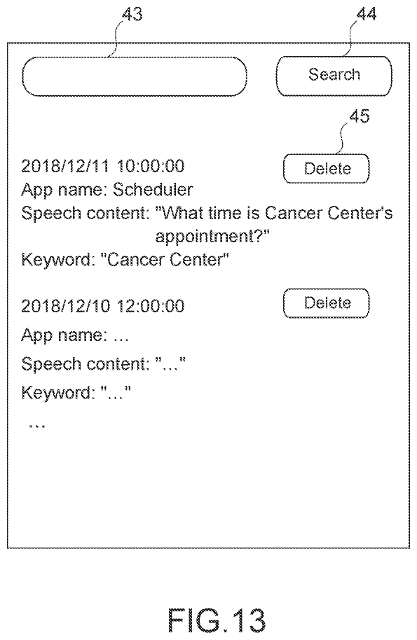

FIGS. 12 and 13 schematically illustrate examples of a deletion of speech information that is performed by the user 1.

As illustrated in FIG. 12, the user 1 speaks to the agent 10 “Show me the log”. The agent 10 displays a history of speech information in response to the instruction given by the user 1. In the present embodiment, pieces of speech information are numbered in order from a latest piece of speech information in the history.

When the user 1 speaks to the agent 10 “Delete (2)”, the deletion section 34 deletes a corresponding piece of speech information on the basis of the instruction given by the user 1. In other words, a record corresponding to information (2) in the history is deleted from the user log DB.

Note that an instruction used to delete speech information is not limited, and may be set discretionarily. For example, the speech information may be deletable by indicating a time stamp such as “Delete information at 10:00 on Dec. 11, 2018”, instead of a number being indicated. Further, speech information may be deletable by indicating an app name, a speech content, or a keyword, or by indicating a combination thereof.

In the example illustrated in FIG. 13, a search word input section 43 and a search button 44 are provided to a dedicated page on which a history of speech information is available. Further, a deletion button 45 is set for each of the sequentially displayed pieces of history information.

For example, a search word is input to the search word input section 43 by the user 1. Then, the search button 44 is selected. This results in displaying history information of which a keyword matches the search word.

For example, when “leukemia” is input as a search word, history information that includes “leukemia” as a keyword is displayed. Note that history information of which a keyword includes a search word may be displayed.

The user 1 can delete desired speech information by appropriately selecting the deletion button 45 set for each piece of history information.

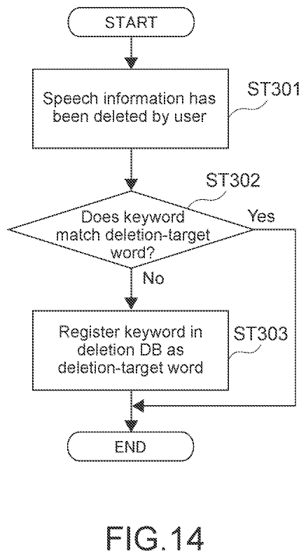

FIG. 14 is a flow chart illustrating an expansion of the deletion DB 36.

For example, as illustrated in FIGS. 12 and 13, the user 1 gives an instruction to perform deletion with respect to a history of speech information (Step 301).

It is determined whether a keyword included in the deleted speech information is a deletion-target word. In other words, it is determined whether a keyword matches a deletion-target word included in the deletion DB 36 (Step 302).

When it has been determined that the keyword is the deletion-target word (No in Step 302), the process is terminated. Note that, for example, the total number of deletions from the deletion DB 36 may be updated.

When it has been determined that the keyword is not the deletion-target word (Yes in Step 302), the keyword is registered in the deletion DB as the deletion-target word (Step 303).

Determination information associated with a deletion-target word stored in the deletion DB 36 may be set discretionarily. For example, setting is performed such that the sensitivity level is “1”, and the total number of deletions is “0”.

As described above, a deletion-target word is newly stored in the deletion DB 36 by the management section 35 in response to a speech content being deleted by the user 1. This makes it possible to increase the number of records in the deletion DB 36 from an initial state. This results in being able to improve the accuracy in extracting a keyword that includes sensitive information or the like, and thus to delete a speech content with a high degree of accuracy.

### Other Embodiments

The present technology is not limited to the embodiments described above, and can achieve various other embodiments.

FIG. 15 is a block diagram illustrating an example of a configuration of hardware of the server apparatus 30.

The server apparatus 30 includes a CPU 201, a read only memory (ROM) 202, a RAM 203, an input/output interface 205, and a bus 204 through which these components are connected to each other. A display section 206, an input section 207, a storage 208, a communication section 209, a drive 210, and the like are connected to the input/output interface 205.

The display section 206 is a display device using, for example, liquid crystal or electroluminescence (EL). Examples of the input section 207 include a keyboard, a pointing device, a touch panel, and other operation apparatuses. When the input section 207 includes a touch panel, the touch panel may be integrated with the display section 206.

The storage 208 is a nonvolatile storage device, and examples of the storage 208 include an HDD, a flash memory, and other solid-state memories. The drive 210 is a device that can drive a removable recording medium 211 such as an optical recording medium, a magnetic recording tape, or the like.

The communication section 209 is a modem, a router, or another communication apparatus that can be connected to, for example, a LAN or a WAN and is used to communicate with another device. The communication section 209 may perform communication wirelessly or by wire. The communication section 209 is often used in a state of being separate from the server apparatus 30.

In the preset embodiment, the communication section 209 enables communication with another apparatus through a network.

Information processing performed by the server apparatus 30 having the configuration of hardware described above is performed by software stored in, for example, the storage 208 or the ROM 202, and hardware resources of the server apparatus 30 working cooperatively. Specifically, the information processing method according to the present technology is performed by loading, into the RAM 203, a program included in the software and stored in the ROM 202 or the like and executing the program.

For example, the program is installed on the server apparatus 30 through the recording medium 211. Alternatively, the program may be installed on the server apparatus 30 through, for example, a global network.

In the embodiments described above, a deletion-target word is defined as a word that includes sensitive information regarding the user 1. Without being limited thereto, the deletion-target word may be a word that includes personal information, such as a name and an address, with which an individual can be identified. Further, a word that includes both sensitive information and personal information may be a deletion-target word. Furthermore, a word based on “specific sensitive personal information” defined in JISQ15001 or “personal information requiring consideration” defined in the Amended Act on the Protection of Personal Information may be defined as a deletion-target word. Of course, any other definition may be performed.

In the embodiments described above, when the user is alone, it is determined that the user 1 is in a state in which a deletion suggestion is allowed to be provided. Without being limited thereto, when the user is with someone, such as his/her family member, who has a close relationship with the user 1, it may also be determined that the user 1 is in a state in which a deletion suggestion is allowed to be provided.

Further, for example, when the user 1 is working on a specific task such as cleaning, it may be determined that the user 1 is not in a state in which a deletion suggestion is allowed to be provided. In other words, state information regarding a user's state determined to be a state in which a deletion suggestion is allowed to be provided, may be set discretionarily.

In the embodiments described above, the sensitivity level is discretionarily set by the user 1. The sensitivity level may be set using any learning algorithm for, for example, various machine learning using the neural network or the deep learning described above.

The information processing apparatus, the information processing method, and the program according to the present technology may be executed and the information processing apparatus according to the present technology may be implemented by a computer included in a communication terminal and another computer working cooperatively, the other computer being capable of communicating with the computer through, for example, a network.

In other words, the information processing apparatus, the information processing method, and the program according to the present technology can be executed not only in a computer system that includes a single computer, but also in a computer system in which a plurality of computers operates cooperatively. Note that, in the present disclosure, the system refers to a set of components (such as apparatuses and modules (parts)) and it does not matter whether all of the components are in a single housing. Thus, a plurality of apparatuses accommodated in separate housings and connected to each other through a network, and a single apparatus in which a plurality of modules is accommodated in a single housing are both the system.

The execution of the information processing apparatus, the information processing method, and the program according to the present technology by the computer system includes, for example, both a case in which the extraction of a keyword, the deletion suggestion, the determination of a deletion-target word, and the like are executed by a single computer; and a case in which the respective processes are executed by different computers. Further, the execution of each process by a specified computer includes causing another computer to execute a portion of or all of the process and acquiring a result of it.

In other words, the information processing apparatus, the information processing method, and the program according to the present technology are also applicable to a configuration of cloud computing in which a single function is shared and cooperatively processed by a plurality of apparatuses through a network.

The respective configurations of the keyword extraction section, the suggestion section, the deletion section, and the like; the flow of controlling a deletion suggestion; and the like described with reference to the respective figures are merely embodiments, and any modifications may be made thereto without departing from the spirit of the present technology. In other words, for example, any other configurations or algorithms for purpose of practicing the present technology may be adopted.

Note that the effects described in the present disclosure are not limitative but are merely illustrative, and other effects may be provided. The above-described description of the plurality of effects does not necessarily mean that the plurality of effects is provided at the same time. The above-described description means that at least one of the effects described above is provided depending on, for example, a condition. Of course, there is a possibility that an effect that is not described in the present disclosure will be provided.

At least two of the features of the present technology described above can also be combined. In other words, various features described in the respective embodiments may be combined discretionarily regardless of the embodiments.

Note that the present technology may also take the following configurations.

(1) An information processing apparatus, including:

an extraction section that extracts a deletion-target word from speech information that includes a content of speech of a target person; and

a suggestion section that is capable of providing, to the target person, a deletion suggestion for deleting the deletion-target word when the deletion-target word is extracted.

(2) The information processing apparatus according to (1), in which

the deletion-target word is a word that includes sensitive information regarding the target person.

(3) The information processing apparatus according to (1) or (2), in which

for each extracted deletion-target word, the suggestion section determines whether to provide the deletion suggestion.

(4) The information processing apparatus according to any one of (1) to (3), in which

the suggestion section provides the deletion suggestion when determination information that is associated with the extracted deletion-target word satisfies a specified suggestion condition.

(5) The information processing apparatus according to (4), in which

the determination information includes a sensitivity-related level of the deletion-target word, and

the suggestion section provides the deletion suggestion when the sensitivity-related level exceeds a threshold.

(6) The information processing apparatus according to (4) or (5), in which

the determination information includes the number of deletions of the deletion-target word that have been performed by another target person, and

the suggestion section provides the deletion suggestion when the number of deletions exceeds a threshold.

(7) The information processing apparatus according to any one of (1) to (6), in which

the suggestion section determines whether to provide the deletion suggestion by comparing information regarding the target person with information regarding another target person who has deleted the deletion-target word.

(8) The information processing apparatus according to any one of (1) to (7), further including

a management section that manages a deletion database that stores therein the deletion-target word, in which

the extraction section refers to the deletion database, and extracts the deletion-target word from the speech information.

(9) The information processing apparatus according to any one of (1) to (8), further including

a storage that stores therein a history of the speech information regarding the target person, in which

the management section stores, in the deletion database and as the deletion-target word, a keyword that has been extracted from the speech information in the history, and has been designated to be deleted by a deletion instruction being given by the target person.

(10) The information processing apparatus according to any one of (1) to (9), in which

on the basis of state information regarding a state of the target person, the suggestion section determines whether the target person is in a state in which the deletion suggestion is allowed to be provided.

(11) The information processing apparatus according to any one of (1) to (10), in which

when the target person is alone, the suggestion section determines that the target person is in a state in which the deletion suggestion is allowed to be provided.

(12) The information processing apparatus according to any one of (1) to (11), in which

the suggestion section presents suggestion information including the deletion-target word to the target person such that deleting or not deleting the deletion-target word is selectable by the target person.

(13) The information processing apparatus according to (12), in which

the suggestion information includes the speech information from which the deletion-target word has been extracted, and

the suggestion section presents the suggestion information to the target person such that deleting or not deleting the speech information from which the deletion-target word has been extracted, is selectable by the target person.

(14) The information processing apparatus according to (12) or (13), in which

the suggestion section presents the suggestion information to the target person using at least one of an image or sound.

(15) The information processing apparatus according to any one of (1) to (14), further including:

a storage that stores therein a history of the speech information regarding the target person; and

a deletion section that deletes the speech information from the history when the target person selects deleting the deletion-target word in response to the deletion suggestion, the speech information being speech information from which the deletion-target word has been extracted.

(16) The information processing apparatus according to any one of (1) to (15), in which

the extraction section extracts the deletion-target word from the speech information generated by a voice interactive system that is used by the target person.

(17) An information processing method that is performed by a computer system, the information processing method including:

extracting a deletion-target word from speech information that includes a content of speech of a target person; and

providing, to the target person, a deletion suggestion for deleting the deletion-target word when the deletion-target word is extracted.

(19) A program that causes a computer system to perform a process including:

extracting a deletion-target word from speech information that includes a content of speech of a target person; and

providing, to the target person, a deletion suggestion for deleting the deletion-target word when the deletion-target word is extracted.

### REFERENCE SIGNS LIST

1 user
10 agent
20 user terminal
30 server apparatus
31 keyword extraction section
32 keyword determination section
33 suggestion section
34 deletion section
35 management section
36 deletion DB
37 user log DB
100 voice interactive system

1. An information processing apparatus, comprising:
an extraction section that extracts a deletion-target word from speech information that includes a content of speech of a target person; and
a suggestion section that is capable of providing, to the target person, a deletion suggestion for deleting the deletion-target word when the deletion-target word is extracted.

2. The information processing apparatus according to claim 1, wherein
the deletion-target word is a word that includes sensitive information regarding the target person.

3. The information processing apparatus according to claim 1, wherein
for each extracted deletion-target word, the suggestion section determines whether to provide the deletion suggestion.

4. The information processing apparatus according to claim 1, wherein
the suggestion section provides the deletion suggestion when determination information that is associated with the extracted deletion-target word satisfies a specified suggestion condition.

5. The information processing apparatus according to claim 4, wherein
the determination information includes a sensitivity-related level of the deletion-target word, and
the suggestion section provides the deletion suggestion when the sensitivity-related level exceeds a threshold.

6. The information processing apparatus according to claim 4, wherein
the determination information includes the number of deletions of the deletion-target word that have been performed by another target person, and
the suggestion section provides the deletion suggestion when the number of deletions exceeds a threshold.

7. The information processing apparatus according to claim 1, wherein
the suggestion section determines whether to provide the deletion suggestion by comparing information regarding the target person with information regarding another target person who has deleted the deletion-target word.

8. The information processing apparatus according to claim 1, further comprising
a management section that manages a deletion database that stores therein the deletion-target word, wherein
the extraction section refers to the deletion database, and extracts the deletion-target word from the speech information.

9. The information processing apparatus according to claim 1, further comprising
a storage that stores therein a history of the speech information regarding the target person, wherein
the management section stores, in the deletion database and as the deletion-target word, a keyword that has been extracted from the speech information in the history, and has been designated to be deleted by a deletion instruction being given by the target person.

10. The information processing apparatus according to claim 1, wherein
on a basis of state information regarding a state of the target person, the suggestion section determines whether the target person is in a state in which the deletion suggestion is allowed to be provided.

11. The information processing apparatus according to claim 1, wherein
when the target person is alone, the suggestion section determines that the target person is in a state in which the deletion suggestion is allowed to be provided.

12. The information processing apparatus according to claim 1, wherein
the suggestion section presents suggestion information including the deletion-target word to the target person such that deleting or not deleting the deletion-target word is selectable by the target person.

13. The information processing apparatus according to claim 12, wherein
the suggestion information includes the speech information from which the deletion-target word has been extracted, and
the suggestion section presents the suggestion information to the target person such that deleting or not deleting the speech information from which the deletion-target word has been extracted, is selectable by the target person.

14. The information processing apparatus according to claim 12, wherein
the suggestion section presents the suggestion information to the target person using at least one of an image or sound.

15. The information processing apparatus according to claim 1, further comprising:
a storage that stores therein a history of the speech information regarding the target person; and
a deletion section that deletes the speech information from the history when the target person selects deleting the deletion-target word in response to the deletion suggestion, the speech information being speech information from which the deletion-target word has been extracted.

16. The information processing apparatus according to claim 1, wherein
the extraction section extracts the deletion-target word from the speech information generated by a voice interactive system that is used by the target person.

17. An information processing method that is performed by a computer system, the information processing method comprising:
extracting a deletion-target word from speech information that includes a content of speech of a target person; and
providing, to the target person, a deletion suggestion for deleting the deletion-target word when the deletion-target word is extracted.

19. A program that causes a computer system to perform a process comprising:
extracting a deletion-target word from speech information that includes a content of speech of a target person; and
providing, to the target person, a deletion suggestion for deleting the deletion-target word when the deletion-target word is extracted.
